(19) United States
(12) Patent Application Publication
(10) Pub. No.: US 2025/0342319 A1
(43) Pub. Date: Nov. 6, 2025

(54) SYSTEMS AND METHODS FOR MANAGING INTERACTIONS WITH GENERATIVE ARTIFICIAL INTELLIGENCE MODELS

(71) Applicant: NVIDIA Corporation, Santa Clara, CA (US)

(72) Inventors: Jonathan Michael COHEN, Mountain View, CA (US); Ryan ANGILLY, Denver, CO (US); Ryan Edward LEARY, Woodstock, GA (US)

(73) Assignee: NVIDIA Corporation, Santa Clara, CA (US)

(21) Appl. No.: 18/651,799

(22) Filed: May 1, 2024

(51) Int. Cl. G06F 40/40

(52) U.S. Cl. CPC G06F 40/40

(57) ABSTRACT

In various examples, systems and methods are disclosed that relate to managing interactions with generative artificial intelligence models. For example, a system can receive data associated with a system prompt, the system prompt including a first string of text. The system can then receive data associated with a task prompt, the task prompt including a second string of text configured to cause a large language model (LLM) to generate an output. The system can generate a model prompt including a third string of text based at least on the first string of text and the second string of text. In examples, the system can provide the model prompt to the LLM to cause the LLM to generate the output, the output including an answer that is determined based at least on a context associated with the third string of text.

### BACKGROUND

Models, such as large language models (LLMs), can implement powerful machine learning-based techniques that can involve taking a string of text as an input and providing a contextually-relevant string of text as an output. LLMs are able to provide such complex outputs by processing the input text often using an encoder, at least one attention mechanism, and a decoder to both draw out context across the input and synthesize a human-like output based at least on the context. And with the early success of generic LLMs, significant effort is now being focused on improving the quality of the outputs of LLMs while also maintaining consistency across outputs. But the management of these LLMs during the development and implementation phases can be difficult.

### SUMMARY

Embodiments of the present disclosure relate to managing interactions with generative artificial intelligence models. In some embodiments, systems and methods are disclosed that involve managing interactions with generative artificial intelligence models during development of system prompts for LLMs.

The presently-disclosed techniques address the difficulty involved in managing LLMs, including those trained to provide responses to generic input strings that are subsequently configured for domain-specific use. For example, conventional techniques involve developers first developing systems capable of obtaining input strings to be provided to the LLMs during testing or implementation. In instances, developers must also develop systems capable of obtaining bespoke prompts that are configured to guide the LLM when generating outputs. Developers must then coordinate between the system involved to combine the input strings with the prompts prior to being provided to an LLM. This entire process can be implemented without specialized development environments through the use of conventional development tools. In contrast, systems and methods described herein allow system prompts to be generated, tested, updated, and implemented in a single development environment and with fewer system-specific configurations. As a result of coordinating receipt and combination of the inputs necessary to configure the LLMs to a single environment, LLM configurations can be configured faster and with greater efficiency.

At least one aspect relates to one or more processors. The one or more processors can include one or more circuits to: receive, using a first graphical user interface (GUI), data associated with a system prompt including a first string of text; receive, using the first GUI or a second GUI, data associated with a task prompt including at least a second string of text configured to cause an LLM to generate an output; generate a model prompt comprising a third string of text based at least on the first string of text and the second string of text; and/or provide the model prompt to the LLM to cause the LLM to generate the output, the output including an answer that is determined based at least on a context associated with the third string of text.

In some implementations, the one or more circuits are to: receive data associated with an indication of the LLM from among a plurality of LLMs, where individual LLMs of the plurality of LLMs are trained using at least partially different training datasets or training parameters. The one or more circuits can: provide the model prompt to the LLM to cause the LLM to generate the output based at least on the indication of the LLM. In some implementations, the one or more circuits can: receive data associated with one or more example strings of text. The model prompt can be further generated based at least on the one or more example strings of text.

In some implementations, the one or more circuits can receive data associated with a dataset identifier; and can receive a dataset based at least on the dataset identifier, the dataset including one or more example strings of text. The model prompt can be further generated based at least on the dataset.

In some implementations, the one or more circuits can: receive data associated with a seed, the seed including a random number. The model prompt can be further based at least on the seed. In some implementations, the one or more circuits can: receive the data associated with the task prompt from an endpoint, the endpoint associated with display of at least one of the first GUI or the second GUI.

In some implementations, the one or more circuits can: receive the data associated with the system prompt from a first device of a plurality of devices. The one or more circuits can generate data associated with a project template based at least on the system prompt, the data configured to prepopulate one or more fields of the first graphical user interface based at least on the system prompt; and can store the data associated with the project template in a database, the database accessible by a second device of the plurality of devices. In some implementations, the one or more circuits can receive a request for the project template from the second device of the plurality of devices; and can determine the data associated with the project template based at least on the request; and provide the data associated with the project template to the second device.

In some implementations, the one or more processors are comprised in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system implementing large language models (LLMs); a system implementing vision language models (VLMs); a system for hosting one or more real-time streaming applications; a system for performing light transport simulation; a system for performing collaborative content creation for 3D assets; or a system implemented at least partially using cloud computing resources.

At least one aspect relates to a method. The method can include receiving, based at least on one or more first user inputs, data associated with a system prompt that includes a first string of text. The method can include receiving, based at least on one or more second user inputs, data associated with a task prompt that includes at least a second string of text configured to cause a large language model (LLM) to generate an output. The method can include generating a model prompt including at least a third string of text based at least on the first string of text and the second string of text. The method can include providing the model prompt to the LLM to cause the LLM to generate the output including an answer that is determined based at least on a context associated with the third string of text.

In some implementations, the method can include receiving data associated with an indication of the LLM from among a plurality of LLMs, where each LLM of the plurality of LLMs are trained based at least on different training datasets; and can include providing the model prompt to the LLM to cause the LLM to generate the output based at least on the indication of the LLM.

In some implementations, the method can include receiving data associated with one or more example strings of text. Generating the model prompt can include: generating the model prompt comprising the third string of text based at least on the first string of text, the second string of text, and the one or more example strings of text. In some implementations, the method can include receiving data associated with a dataset identifier; and can include receiving the dataset based at least on the dataset identifier, the dataset comprising one or more example strings of text. Generating the model prompt can include generating the model prompt comprising the third string of text based at least on the first string of text, the second string of text, and the one or more example strings of text.

In some implementations, the method can include receiving data associated with a seed, the seed comprising a random number. Generating the model prompt can include generating the model prompt comprising the third string of text based at least on the first string of text, the second string of text, and the seed. In some implementations, receiving the data associated with a task prompt can include receiving the data associated with the task prompt from an endpoint, the endpoint associated with display of a graphical user interface. In some implementations, receiving, via the first graphical user interface, the data associated with a system prompt can include: receiving the data associated with the system prompt from a first device of a plurality of devices. In some implementations, the method can include generating data associated with a project template based at least on the system prompt, the data to prepopulate one or more fields of the first graphical user interface based at least on the system prompt. The method can include storing the data associated with the project template in a database, the database accessible by a second device of the plurality of devices. In some implementations, the method can include receiving a request for the project template from the second device of the plurality of devices. The method can include determining the data associated with the project template based at least on the request. The method can include providing the data associated with the project template to the second device.

In some implementations, the method can be implemented in at least one of: a control system for an autonomous or semi-autonomous machine; a perception system for the autonomous or semi-autonomous machine; a system for performing simulation operations; a system for performing digital twin operations; a system for performing light transport simulation; a system for performing collaborative content creation for 3D assets; a system for performing deep learning operations; a system for presenting at least one of augmented reality content, virtual reality content, or mixed reality content; a system for hosting one or more real-time streaming applications; a system implemented using an edge device; a system implemented using a robot; a system for performing conversational AI operations; a system that implements one or more large language models (LLMs); a system for generating synthetic data; a system incorporating one or more virtual machines (VMs); a system implemented at least partially in a data center; or a system implemented at least partially using cloud computing resources.

At least one aspect relates to a system. The system can include one or more processors to perform operations comprising receiving, via a first graphical user interface, data associated with a system prompt, the system prompt comprising a first string of text; receiving, via a second graphical user interface, data associated with a task prompt, the task prompt comprising a second string of text configured to cause a large language model (LLM) to generate an output; and/or generating a model prompt comprising a third string of text based at least on the first string of text and the second string of text; and providing the model prompt to the LLM to cause the LLM to generate the output, the output comprising an answer that is determined based at least on a context associated with the third string of text.

In some implementations, the system is comprised in at least one of: a control system for an autonomous or semi-autonomous machine; a perception system for an autonomous or semi-autonomous machine; a system implemented using a robot; an aerial system; a medical system; a boating system; a smart area monitoring system; a system for performing deep learning operations; a system for performing simulation operations; a system for generating or presenting virtual reality (VR) content, augmented reality (AR) content, or mixed reality (MR) content; a system for performing digital twin operations; a system implemented using an edge device; a system incorporating one or more virtual machines (VMs); a system for generating synthetic data; a system implemented at least partially in a data center; a system for performing conversational artificial intelligence (AI) operations; a system for performing generative AI operations; a system implementing language models; a system implementing large language models (LLMs); a system implementing vision language models (VLMs); a system for hosting one or more real-time streaming applications; a system for performing light transport simulation; a system for performing collaborative content creation for 3D assets; or a system implemented at least partially using cloud computing resources.

At least one aspect relates to a system. The system can include one or more processors to cause execution of an application that communicates, using one or more application programming interfaces (APIs), with an endpoint. The endpoint can implement a large language model (LLM) selected from a set of LLMs with a selected set of parameters. The selected set of parameters can include at least one of a knowledge base for performing retrieval augmented generation (RAG), one or more customizations to the LLM, one or more customizations to a prompt generator, or one or more application-specific guardrails for aligning the LLM to an application-specific domain.

In some implementations, the endpoint can be configured using one or more graphical user interfaces (GUIs) and based at least on one or more inputs to the GUI that indicate at least one of a selection of the LLM from the set of LLMs, a selection of the knowledge base, a selection of the one or more customizations to the LLM, a selection of the one or more customizations to the prompt generator, or an indication of the one or more application-specific guardrails. The endpoint can be dynamically and automatically updated, without requiring an update to the application, to implement updated or modified versions at least one of the LLM, the knowledge base, the one or more customizations to the LLM, the one or more customizations to the prompt generator, or the one or more application-specific guardrails.

### BRIEF DESCRIPTION OF THE DRAWINGS

The present systems and methods for managing interactions with generative artificial intelligence models are described in detail below with reference to the attached drawing figures, wherein:

FIG. 1 is a block diagram of an example environment for implementing systems and methods to manage interactions with generative artificial intelligence models, in accordance with embodiments of the present disclosure;

FIGS. 2A-2E are example user interfaces, in accordance with embodiments of the present disclosure;

FIG. 3 is a flow diagram of an example method for managing interactions with generative artificial intelligence models, in accordance with embodiments of the present disclosure;

FIG. 4 is a block diagram of an example computing device suitable for use in implementing some embodiments of the present disclosure; and

FIG. 5 is a block diagram of an example data center suitable for use in implementing some embodiments of the present disclosure.

### DETAILED DESCRIPTION

Systems and methods are disclosed related to management of interactions with generative artificial intelligence models. It will be understood that, although various implements are described in association with systems and methods that manage interactions with LLMs, the systems and methods described herein can be applied to a variety of other domains involving similar or different generative artificial intelligence models, along with the techniques implemented herein.

As discussed above, LLMs (and/or VLMs) can be configured to take a string of text (or other data type, such as image, audio, video, etc.) as an input and provide a contextually-relevant string of text (or other date type) as an output. Although the discussion herein is primarily related to LLMs, this is not intended to be limiting, and the systems and methods described herein may be applicable to other language models, VLMs, and/or other types of machine learning or neural network models. One way of improving the output of an LLM is to preconfigure the input string of text to guide the LLM when generating the output. For example, when an input is received and includes a simple or highly-complex string, the input may first be combined with a system prompt before being provided to the LLM. The system prompt can limit the scope of the response to a particular domain, specify a particular task that the LLM is performing, and/or even specify the style and tone of the response. By pairing the input string with a specific system prompt, the LLM can be guided to provide more focused and contextually-relevant outputs. In some embodiments, the system prompt can be further paired with one or more strings of text (e.g., context prompts) that further instruct the LLM. Through careful development of these additional strings of text, systems described herein can implement in-context learning or zero-shot learning such that, when paired with a string of text representing a task prompt (e.g., input by an end user), the LLM can be fine-tuned at inference to perform similar as if the LLM were tuned using comparable p-tuning or fine-tuning techniques.

In one illustrative example, where an LLM is being used to translate text from one language to another, developers can first configure a system to obtain the input string in the first language along with a request to translate the input string to a different language. The developer can then configure the system to combine the input string with a system prompt indicating that the output string should represent the first string in the specified language, and can provide the combined input string and system prompt to the LLM. In a more complex example, where the LLM is being used to generate recipes in response to questions regarding nutritional planning, the developer can again configure the system to obtain the input string, combine the input string with a system prompt indicating that the output string should represent a set of foods or recipe, and can provide the combined input string and system prompt to the LLM. In this example, the system prompt can be configured to implement what is referred to as few-shot learning, and can include examples of what the output should include (e.g., a list of example foods and quantities from other recipes) to fine-tune the output at the point of inference.

The present disclosure relates to systems and methods for managing inputs provided to an LLM. More specifically, in an embodiment, a processor comprises one or more circuits to (1) receive, via a first graphical user interface, data associated with a system prompt, the system prompt comprising a first string of text, (2) receive, via the first graphical user interface or a second graphical user interface, data associated with a user input, the user input comprising a second string of text configured to cause an LLM to generate an output; (3) generate a model prompt (sometimes referred to as a full prompt) comprising a third string of text based at least on the first string of text and the second string of text; and/or (4) provide the model prompt to the LLM to cause the LLM to generate the output, the output comprising an answer that is determined based at least on a context associated with the third string of text.

When implemented, the disclosed techniques allow system prompts to be generated, tested, updated, and implemented (e.g., via edge devices configured to interface with devices in a distributed or cloud computing environment such as client devices described herein) in support of online use of an LLM. These system prompts can guide the LLM during generation of outputs by the LLM, improving the quality of the outputs without additional training and/or updating of the model weights. Additionally, the disclosed system prompts can cause an LLM to generate an output that targets a specific domain (e.g., translation from one language to another, response to specific queries, and/or the like) that can adapt more generic LLMs to such domains without the need for significant additional training and/or updating of the LLMs. This can save significant time and computing resources that would otherwise be dedicated to dataset curation and model training and/or updating. Additionally, the presently-disclosed techniques enable the configuration of system prompts by individuals (e.g., individuals that are not software developers or engineers) and publication of such system prompts for use in association with a given endpoint (e.g., a text field on a website, etc.) without requiring the system prompts to conform to conventions associated with any particular programming language. In this way, the overall prompt engineering process can be accelerated through the use of developer tools enabling the techniques disclosed herein, enabling individuals to quickly iterate when testing system prompts to be deployed.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more large language models (LLMs), systems implementing one or more vision language models (VLMs), systems implemented at least partially using cloud computing resources, and/or other types of systems.

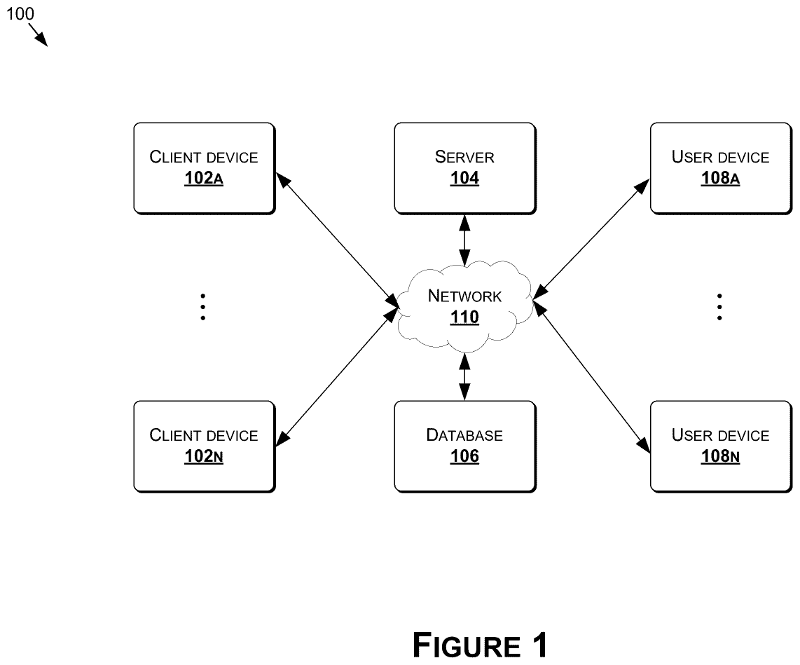

With reference to FIG. 1, FIG. 1 is an example environment 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in FIG. 1, the environment 100 includes client devices 102a-102n (referred to individually as client device 102 and collectively as client devices 102, unless stated otherwise), a server 104, a database 106, user devices 108a-108n (referred to individually as user device 108 and collectively as user devices 108, unless stated otherwise), and network 110. In some embodiments, the client devices 102, server 104, database 106, and user devices 108 can interconnect (e.g., establish a connection to communicate) via wired and/or wireless connections. For example, the client devices 102, server 104, database 106, and user devices 108 can interconnect via one or more networks as described herein to transmit and/or receive data. In some implementations, the client devices 102, server 104, database 106, and user devices 108 can transmit and/or receive any of the data described herein, as described herein.

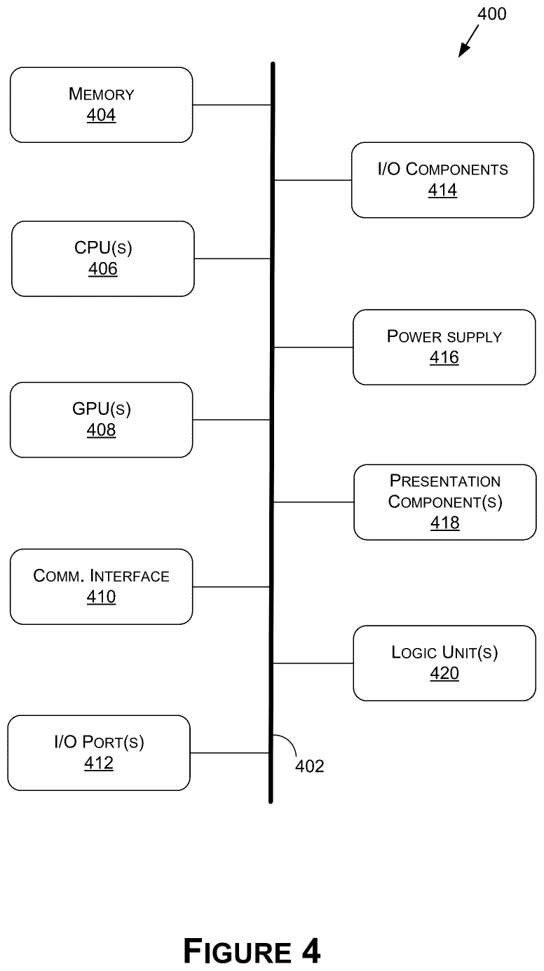

The client devices 102 can include one or more devices configured to communicate with the server 104, the database 106, and/or one or more user devices 108 via network 110. For example, the client devices 102 can include a device such as a mobile device, a laptop computer, a desktop computer, and/or the like that is capable of receiving user input, transmitting data associated with the user input to one or more other devices of FIG. 1, and generating data to cause a display to generate an output. In some implementations, the client devices 102 can be configured to transmit and/or receive data to and/or from the server 104. For example, the client devices 102 can be configured to transmit and/or receive any of the data described herein. In some embodiments, the client devices 102 can include one or more components that are the same as, or similar to, one or more of the components of the computing device 400 of FIG. 4.

The server 104 can include one or more devices configured to communicate with the client devices 102, the database 106, and/or one or more user devices 108 via network 110. For example, the server 104 can include a device such as a laptop computer, a desktop computer, a rack-mounted server, a virtual machine, and/or the like. In some implementations, the server 104 can be configured to transmit and/or receive data to and/or from the client devices 102, the database 106, and/or the user devices 108. For example, the client devices 102 can be configured to transmit and/or receive any of the data described herein. In some embodiments, the server 104 can include one or more components that are the same as, or similar to, one or more of the components of the computing device 400 of FIG. 4.

The database 106 can include one or more devices configured to communicate with the client devices 102, the server 104, and/or one or more user devices 108 via network 110. For example, the database 106 can include a device such as a one or more non-transitory computer-readable mediums configured to store and retrieve data as described herein. In some implementations, the database 106 can be the same as, or similar to, the server 104 and configured to transmit and/or receive data to and/or from the client devices 102, the server 104, and/or the user devices 108. For example, the server 106 can be configured to transmit and/or receive any of the data described herein. In some embodiments, the database 106 can include one or more components that are the same as, or similar to, one or more of the components of the computing device 400 of FIG. 4.

The user devices 108 can include one or more devices configured to communicate with the client devices 102, the server 104, and/or the database 106 via network 110. For example, the user devices 108 can include a device such as a mobile device, a laptop computer, a desktop computer, and/or the like that is capable of receiving user input, transmitting data associated with the user input to one or more other devices of FIG. 1, and generating data to cause a display to generate an output. In some implementations, the user devices 108 can be configured to transmit and/or receive data to and/or from the server 104. For example, the client devices 102 can be configured to transmit and/or receive any of the data described herein. In some embodiments, the user devices 108 can include one or more components that are the same as, or similar to, one or more of the components of the computing device 400 of FIG. 4. In some embodiments, the user devices 108 are associate with end-users (e.g., individuals that were not involved in the creation of one or more of the project templates described herein).

With continued reference to FIG. 1, the server 104 can be configured to receive data associated with input provided by a user at a client device 102. For example, the server 104 can be configured to receive data associated with input provided by a user at a client device 102 as the user is configuring one or more project templates and/or pipelines described herein.

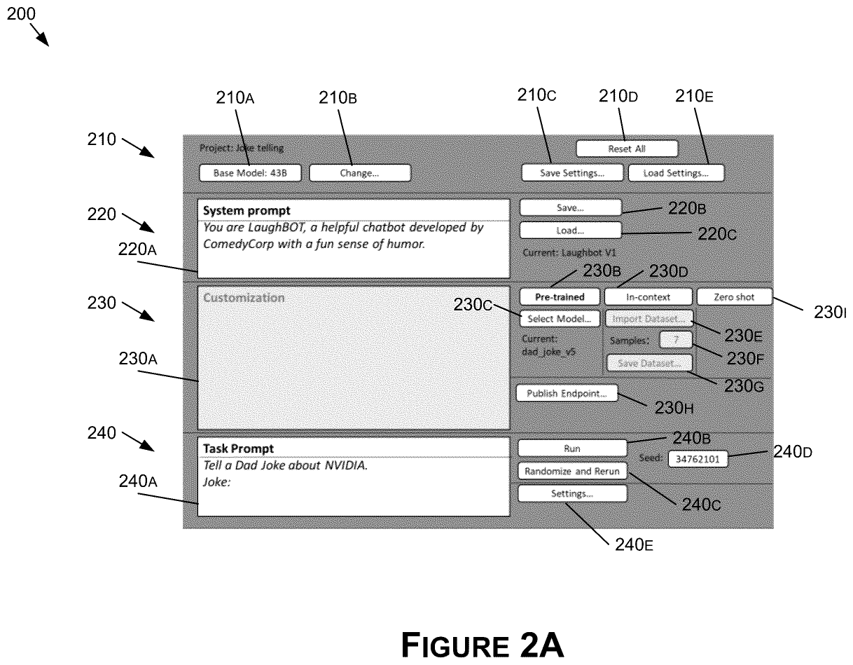

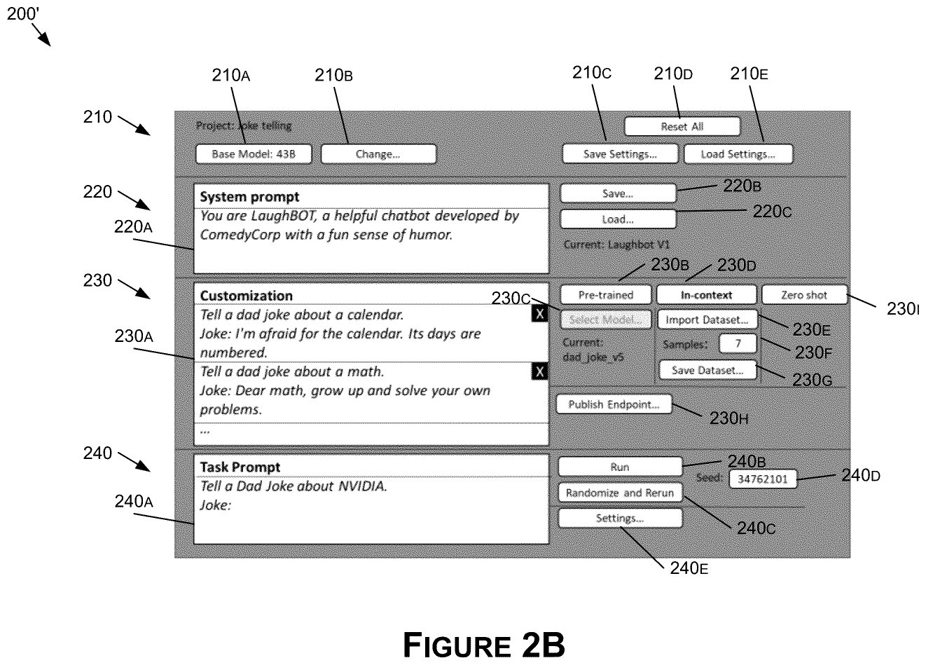

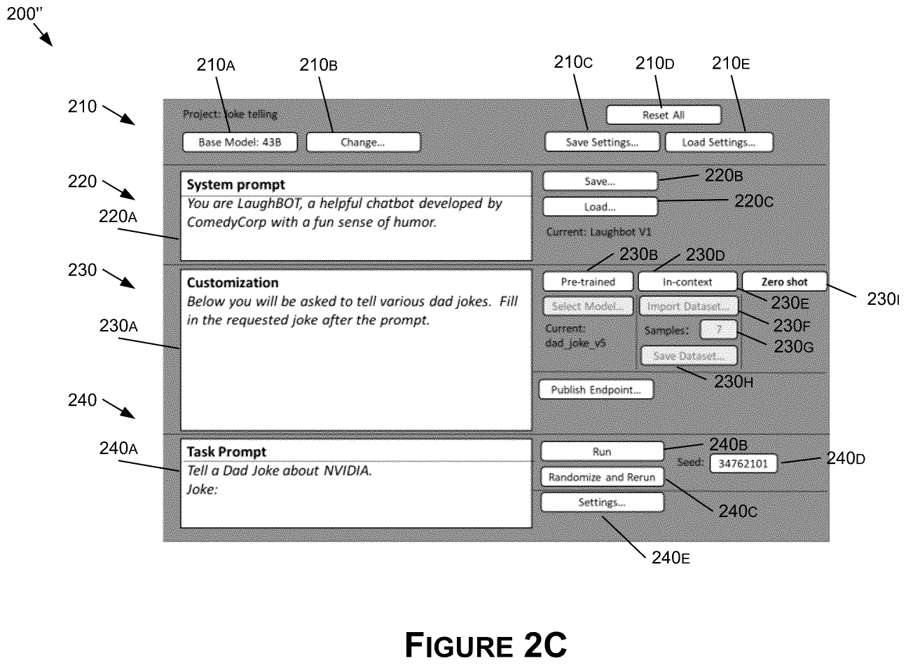

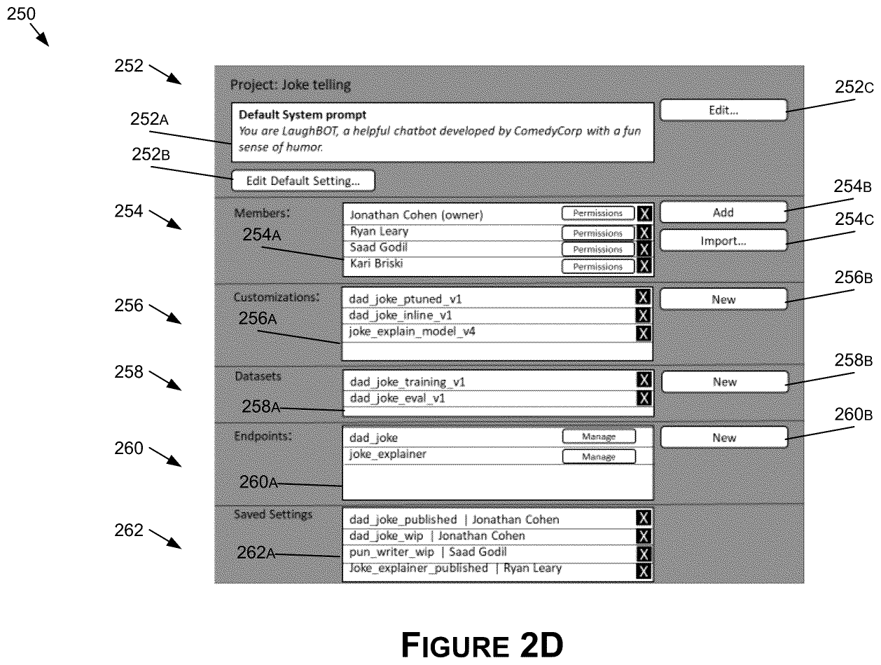

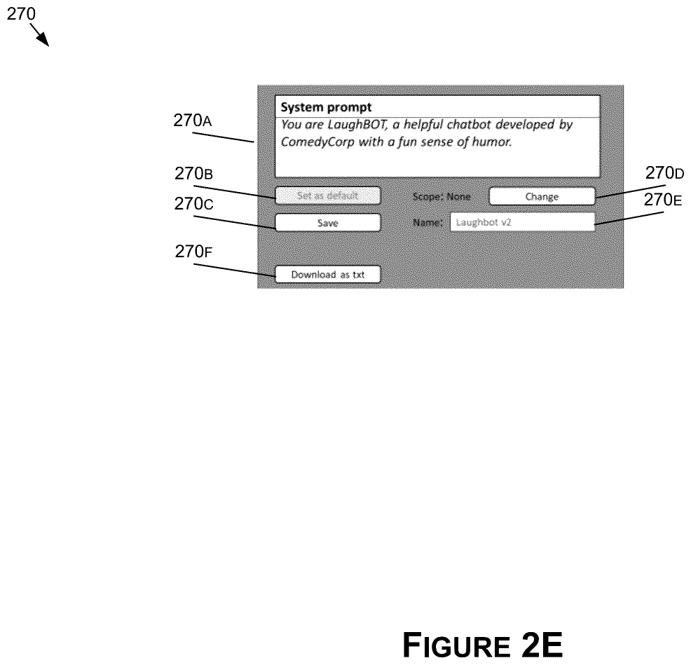

In an example, the server 104 can be configured to receive data associated with a system prompt from a client device 102. In some embodiments, the server 104 can receive the data associated with the system prompt from the client device 102 based at least in part on the client device 102 receiving input from a user controlling the client device 102. For example, the client device 102 can receive input from a user (e.g., a prompt engineer generating and/or configuring one or more aspects of a project template that can be used to generate data input to an LLM) representing the system prompt. The input provided by the user to the client device 102 can include selection by the user of one or more portions of a graphical user interface (e.g., one or more fields, buttons, regions, and/or the like). For example, when the graphical user interface(s) of FIGS. 2A-2E are displayed on a display device of one or more client devices 102, the input provided by users to the corresponding client devices 102 can include selection and/or input of values to the one or more portions of user interfaces.

In examples, the client device 102 can generate and display a first graphical user interface (see, e.g., FIGS. 2A-2C) via a display device (not explicitly shown) of the client device 102. For example, the server 104 can generate data associated with the first graphical user interface and transmit the data to the client device 102. In this example, the data associated with the first graphical user interface can be configured to cause the display device to output the first graphical user interface. Once displayed, the user can provide input via one or more input devices (e.g., keyboards, mice, etc.) of the client device 102. In examples, the user input can include selection or input of one or more system prompts, an indication of a selection of one or more models (e.g., base models, pretrained models, and/or the like), selection of one or more prompts to provide to a model, selection of one or more seeds and/or seed values, an indication to publish a project template to an endpoint (e.g., an endpoint associated with one or more application programming interfaces (APIs)), and/or the like.

In some embodiments, the system prompt can include one or more strings of text. For example, the system prompt can include a string of text that is configured to be provided as part of an input to an LLM to cause the LLM to generate an output that is based at least in part on (e.g., is consistent with) the string of text. In one illustrative example, as shown in FIGS. 2A-2C, the string of text can include “You are a LaughBot, a helpful chatbot developed by ComedyCorp with a fun sense of humor.” In this illustrative example, the string of text can be provided to an LLM to cause the LLM to provide outputs that are consistent with the string of text, such as output strings of text that are of a given genre (e.g., comedy), subject matter (e.g., jokes), and/or the like. While this illustrative example includes a string of text representing a single sentence, it will be understood that the string of text can include multiple strings representing sentences, words, phrases, and/or the like. In yet another illustrative example, a string of text associated with a system prompt can include “You are the rapper Mr. Rapper. You have just completed your PhD in Computer Science and have a job as a Staff Software Engineer at SoftwareCorp.” In another illustrative example, a string of text associated with a system prompt can include “You are a helpful AI assistant. Below is some information followed by a question. You will think carefully and heavily weigh the information below when responding to the final question.”

In some embodiments, user input indicating a selection of one or more models can include an indication identifying a base model or one or more pre-trained models to be used by the server to generate the outputs described herein. For example, the selection of a base model can include selection of one or more foundational models trained to provide contextually-relevant strings of text as outputs in response to any input. In examples, the selection of one or more pre-trained models can include selection of one or more base models that were further trained and/or updated to provide outputs with respect to one or more predetermined contexts or domains. In an illustrative example, a base model can be further trained and/or updated (e.g., fine-tuned) to provide outputs representing jokes in a certain style (e.g., a “Dad Joke”), specific outputs (e.g., outputs simulating a chatbot responding to questions about a particular organization's products or services), and/or the like. In some embodiments, the one or more pre-trained models can include models that were trained and/or updated based at least in part on different training datasets. In the above illustrative example, a model can be updated/trained based at least in part on a dataset including multiple strings of text representing jokes in a certain style. In another illustrative example, one or more pre-trained models can include models that were trained based at least in part on strings of text representing question and answer pairs generated during interactions between individuals and/or chatbots. While the present disclosure includes examples discussed involving models updated/trained based at least in part on strings of text in certain contexts (e.g., comedy, chatbots) it will be understood that the principles of the present disclosure are not necessarily limited to any given context.

In some embodiments, the one or more context prompts to provide to a model can include one or more in-context learning prompts. In some embodiments, in-context learning prompts can include strings of text representing instructions to provide as input to a model, strings of text representing examples of outputs to provide to the model, strings of text representing patterns to use when modeling an output of a model, and/or the like. In some embodiments, portions and/or all of an in-context learning prompt can be provided as input to a model. Additionally, or alternatively, a subset of the in-context learning prompts can be selected from one or more predetermined in-context learning prompts. For example, strings of text representing input from a user of one or more example outputs can be stored by the server 104 (e.g., in the database 106) as a dataset along with a dataset identifier and later retrieved by the server 104 based at least in part on input from a client device 102 specifying the in-context learning prompt (e.g., by specifying the dataset identifier). In this example, the in-context learning prompt(s) stored as example outputs can be retrieved based at least in part on inputs provided by other users in control of other user devices 102. In this way, a given in-context learning prompt can be shared (or published) for use by multiple client devices 102. As an illustrative example, and with respect to FIG. 2B, a first example for a given in-context learning prompt can include a first pair of strings: “Tell a dad joke about a calendar.” “Joke: I'm afraid for the calendar. Its days are numbered,” and a second example for the given in-context learning prompt can include a second pair of strings: “Tell a dad joke about math.” “Joke: Dear math, grow up and solve your own problems.” As another illustrative example, a second example for a given in-context learning prompt can include the following: “Wonsville is a city in Rhode Island. Ware is a city in Massachusetts. Waring is a city in Vermont.”

In some embodiments, the one or more context prompts to provide to a model can include one or more zero-shot learning prompts. In some embodiments, zero-shot learning prompts can include one or more strings of text representing a single set of instructions to provide as input to a model. In some embodiments, all of a zero-shot learning prompt can be provided as input to a model. In some embodiments, the zero-shot learning prompt can be stored by the server 104 and can later be retrieved based at least in part on inputs provided by other users in control of other user devices 102. In this way, a given zero-shot learning prompt can be shared (or published) for use by multiple client devices 102. As an illustrative example, and with respect to FIG. 2C, an example of a zero-shot learning prompt can include a string: “Below you will be asked to tell various dad jokes. Fill in the requested joke after the prompt.”

In some embodiments, the one or more context prompts to provide to a model can include a retrieval citation prompt. For example, the retrieval citation prompt can include one or more strings of text representing information relevant to a question that is asked by a task prompt (described below). In some embodiments, the server can retrieve the retrieval citation prompt based at least in part on a task prompt. For example, the server can retrieve the retrieval citation prompt based at least in part on one or more key words or phrases included in the task prompt. One illustrative example of a retrieval citation prompt can include “Title: John Smith Biography; Content: John Smith was born in Ware.” In this example, when the server receives a task prompt that is the same as, or similar to, the string of text “What state was John Smith born in?” the server can query a database based at least in part on one or more words or phrases in the task prompt, recall the illustrative retrieval citation prompt specifying that John Smith was born in Ware, and provide both to an LLM to cause the LLM to generate an output string of text indicating that John Smith was born in Ware.

In some embodiments, the input provided by a user operating a client device 102 can indicate a selection of a seed associated with one or more seed values. For example, a user can provide input to the first graphical user interface via a client device 102 selecting a seed that, when provided as an input to a model configured to receive the seed, causes the model to introduce a degree of randomness to the output. In another example, a user can provide a specific seed (e.g., a specific seed value) as input. And in yet another example, the input can include an indication to cause the server 104 to select a random seed value. In this way, the user can provide input via the client device 102 to cause the server 104 to provide inputs to a model that cause successive outputs for a given input to be varied.

In some embodiments, the server 104 can generate data associated with one or more project templates. For example, the server 104 can generate the data associated with the one or more project templates based at least in part on the inputs to one or more fields of one or more graphical user interfaces provided by a user operating a client device 102. In some examples, the server 104 can then store the data associated with the one or more project templates (e.g., in memory and/or in the database 106) for later retrieval. In some embodiments, the input received from a user at a client device 102 can include an indication to publish one or more project templates. For example, the server 104 can determine a project template based at least in part on the input provided by a user via a client device 102. The project template can represent one or more of the inputs provided by the user via one or more fields of the first graphical user interface, including the one or more system prompts, selection of one or more models, selection of one or more prompts to provide to a model, selection of one or more seed values, an indication to publish a project template to an endpoint, and/or the like. In examples, the server 104 can then store these inputs in association with one another as a project template and make the project template available for use and/or to be updated by other users interacting with the server via one or more other client devices 102.

In some embodiments, server 104 can receive input from a user operating a client device 102 including a request to load one or more of the project templates accessible by the server 104. The client device 102 that transmitted the request can be the same client device 102 involved in generating the project template or a different client device 102. In this example, the server 104 can determine the data associated with the project template based on the request and retrieve the data from the database 106. The server 104 can then populate the one or more fields of the first graphical user interfaces based at least in part on the one or more project templates. By making these project templates available for download by the user operating the client device 102 that developed the project template or by other users operating other client devices 102, users can generate, share, reuse, and improve on project templates (including the discrete components they represent such as system prompts), resulting in faster and more efficient iteration when configuring models for use by the public (e.g., when configuring context-specific LLMs and/or the like).

In some embodiments, the server 104 can be configured to receive data associated with an input representing a task prompt provided by a user at a client device 102 or a user device 108. In some embodiments, the server 104 can receive the data associated with the task prompt from the client device 102 or the user device 108 based at least in part on the respective device receiving input from the user. For example, the client device 102 or the user device 108 can receive input from a user (e.g., an individual providing one or more strings of text as input to an LLM as to cause the LLM to generate an output responsive to the input) representing the task prompt. In one illustrative example, and with continued reference to FIGS. 2A-2C, the input can be represented as “Tell a Dad Joke about NVIDIA.” In this illustrative example, the string of text can be provided as input via a user device 108 to cause the server 104 to provide the string of text as at least part of an input to an LLM to cause the LLM to generate an output string of text. Once generated, the output string of text can be generated via the first graphical user interface of the client device 102 or a second graphical user interface to the user device 108. In this way, the server 104 can receive task prompts during development of a project template or when enabling use of an LLM by users of user devices 108.

In some embodiments, the server 104 can receive the data associated with the system prompt and/or the task prompt based at least in part on an input provided by a user via an endpoint. For example, where the server 104 is included in a distributed or cloud computing environment (e.g., any networked environment where multiple computing devices cooperate to perform one or more operations involved in successful performance of a one or more computing operations), the server 104 can receive the data associated with the system prompt and/or the task prompt from the client devices 102 and/or the user devices 108, where the client devices 102 and user devices 108 are configured to communicate via endpoints (e.g., using one or more APIs) within the distributed computing environment. In some embodiments, the server 104 can cause execution of an application involved in communicating with the endpoint. For example, the server 104 can cause execution of an application that communicates using one or more APIs with one or more endpoints. The one or more endpoints can be associated with the client devices 102 and/or the user devices 108 and can implement an LLM selected from a set of LLMs as described herein.

In examples, the first graphical user interface and the second graphical user interface can be generated at the client devices 102 and the user devices 108, respectively, based at least in part on data associated with the first graphical user interface and the second graphical user interface that is generated by the server 104. In some examples, where the client devices 102 and the user devices 108 include endpoints as described herein, the endpoints can be configured dynamically (e.g., by the server 104) and automatically updated (e.g., without a need to update an application executed by a corresponding application executed by the client devices 102 or the user devices 108) such that the endpoints execute applications that implement updated or modified versions of at least one LLM, knowledge base, customizations to the LLM, customizations to the prompt generator, and/or updated application-specific guardrails as described herein. In some embodiments, the server 104 can generate the data associated with the first graphical user interface and/or the second graphical user interface and can transmit the data to the client device(s) 102 and/or user device(s) 108, respectively. In this example, the data associated with the first graphical user interface and/or the second graphical user interface can be configured to cause the respective devices (e.g., applications executed by the respective devices such as, for example, web browsers and/or the like) to display the first graphical user interface or the second graphical user interface as an output via a display device associated with the client device(s) 102 and/or user device(s) 108.

In some embodiments, the server 104 can generate a model prompt. For example, the server 104 can generate a model prompt based at least in part on the system prompt and the task prompt. In an example, the server 104 can generate the model prompt based at least in part on a string of text associated with the system prompt (e.g., the first string of text) and a string of text associated with the task prompt (e.g., the second string of text). In some embodiments, the model prompt can be generated by combining (e.g., concatenating) a first string of text and a second string of text. For example, the server 104 can generate the model prompt by combining the first string of text and the second string of text to form a third string of text. In this example, the first string of text can be prepended to the second string of text to form the third string of text. In some embodiments, the server 104 can generate a model prompt based at least in part on the system prompt, a context prompt, and a task prompt. For example, the server 104 can generate the model prompt based at least in part the first string of text, one or more strings of text associated with a context prompt, and the second string of text. In this example, the server 104 can append the one or more strings of text associated with the context prompt to the first string of text, and then append the second string of text to form the third string of text.

In some embodiments, the server 104 can provide the model prompt to a model to cause the model to generate an output. For example, the server 104 can provide the model prompt to an LLM to cause the LLM to provide an output that includes a string of text. In some embodiments, the string of text can include an answer that is determined based at least on context associated with the third string of text. For example, the string of text can include an answer that is determined based at least on the string of text associated with the task prompt, where the answer is generated based at least in part on context associated with the string of text of the system prompt.

In some embodiments, the server 104 can cause the LLM to generate an output based at least in part on the model prompt and at least a portion of the input provided by the user operating the client device 102. For example, where the input provided by the user operating the client device 102 includes an indication (e.g., a selection) of an LLM from among a plurality of LLMs, the server 104 can provide the model prompt to the LLM identified from among the plurality of LLMs. In this example, the server 104 can provide the corresponding example strings of text to the LLM selected based at least on the input to cause the LLM to generate the outputs described herein. In yet another example, where the input provided by the user operating the client device 102 includes and/or identifies a seed, the server 104 can provide the model prompt and the seed to the LLM to cause the LLM to generate the outputs described herein.

In examples, the input provided by the user operating the client device 102 can include and/or identify a set of parameters. The set of parameters can include at least one of an identifier of a knowledge base (e.g., a database) for performing retrieval augmented generation (RAG), one or more customizations to the LLM, one or more customizations to a prompt generator (e.g., a system involved in generating a model prompt), or one or more application-specific guardrails for aligning the LLM to an application-specific domain. In these examples, the server 104 can be configured to execute an application that causes the server 104 to receive data (using one or more APIs described herein) from one or more user devices 108 communicating as endpoints with the server 104. The endpoints can be involved in implementing LLMs that specified by the input provided by the user operating the client device 102 in accordance with the set of parameters. For example, the endpoints can be involved in implementing LLMs that interact with one or more RAGs, one or more customizations to the generation of model prompts (e.g., by appending text to the beginning or end of the model prompt before providing the model prompt to an LLM), or one or more application-specific guardrails as described herein.

In some embodiments, the server 104 can generate data associated with the output of the LLM as described herein. For example, the server 104 can generate data associated with the output of the LLM based at least in part on the string output by the LLM. In this example, the server 104 can generate the data such that the data is configured to cause an output device (e.g., a display device, speakers, and/or the like) to output the string output by the LLM. In some embodiments, the server 104 can generate the data such that the data is configured to be output via the second graphical user interface.

In some embodiments, the server 104 can implement one or more application-specific guardrails. For example, the server 104 can implement an LLM as described herein to receive inputs from configured endpoints (e.g., user devices 108), generate model prompts, and provide the model prompts to LLMs to cause the LLMs to generate outputs. In some examples, the server 104 can implement the one or more application-specific guardrails that align the LLM to an application-specific domain by providing the output of the LLM to another model (e.g., a different LLM and/or the like) that is configured to update the output from the LLM. In these examples, the model that receives the output of the LLM can be trained to update the outputs such that certain contexts are included or excluded, or the output of the LLM is updated to exclude potential security vulnerabilities and/or the like.

In some embodiments, the data transmitted between the client devices 102, the server 104, and/or the client devices 108 can be transmitted in accordance with one or more APIs (e.g., one or more RESTful APIs, one or more Create, Read, Update, and Delete (CRUD) APIs, and/or the like). For example, the client devices 102 with access to one or more project templates can configure one or more APIs such that users interacting with a second graphical user interface displayed via the user devices 108 can provide inputs to the server 104 representing task prompts. In one illustrative example, the second graphical user interface can be associated with a website, a desktop application, a smartphone application, and/or the like. In this illustrative example, a user operating a client device 102 can publish a project template such that inputs received via a field of the second graphical user interface receive a task prompt as input and transmit data associated with the string of text to the server 104 in accordance with an API. The server 104 can then provide the task prompt to an LLM based at least in part on the corresponding project template to cause the LLM to generate an output. Data associated with the output can then be provided by the server 104 to the client device 108 in accordance with the API to cause the output to be displayed via the second graphical user interface. In this way, the information associated with the system prompt, the prompt, and/or the like can be abstracted from the user operating the user device 108. And by virtue of implementing the systems and methods described herein, APIs can enable on-the-fly generation of in-context learning prompts from datasets at inference time, with the system, customization, and task prompts being three separate fields represented by the API. In some embodiments, the APIs can be configured such that endpoints can be associated with fixed system and/or context prompts that can be locked (e.g., not providable or updatable) at runtime/inference.

With continued reference to FIG. 1, the server 104 can be configured to support one or more design pipelines (referred to herein as “pipelines”). For example, the server 104 can support one or more design pipelines that include data associated with components used to execute a machine learning model in accordance with a project template. In some embodiments, the server 104 can determine one or more pipelines based at least in part on one or more project templates and/or user inputs described herein. For example, a user can provide input to the server 104 via a client device 102, the input including an indication to initialize and/or update a pipeline. The user can then provide input to the server 104 that specifies one or more project templates and/or one or more settings for a given pipeline. In some embodiments, the server 104 can save, export, or make available for export data associated with the pipeline. When exporting, the server 104 can export the pipeline based at least in part on one or more output formats (e.g., JavaScript Object Notation (JSON), source code, machine-readable code, and/or the like). In some embodiments, the server 104 can save the pipeline during configuration intermittently or with automatic versioning.

In one illustrative example, a user can provide input via a client device 102 to the server 104 via a graphical user interface (e.g., the first graphical user interface and/or one or more other graphical user interfaces). For example, the user can provide input to the client device 102 to navigate to a webpage associated with the server 104. In some embodiments, the client device 102 and the server can communicate via one or more APIs as described herein. The user can then provide input via the client device 102 to manage (e.g., create, edit, delete, and/or the like) a given pipeline, access an existing pipeline, create or update a library of system prompts associated with the pipeline, create or update a library of context prompts (e.g., in-context learning prompts, zero-shot learning prompts, retrieval citation prompts, an/do the like. In examples, the user can have access to the user's pipelines, pipelines created by other users (e.g., within an organization), and/or the like. Once the user creates and/or updates a pipeline, the user can provide input to the server 104 via the client device 102 to assign a name to and/or save the pipeline. In examples, the user can provide input to cause the server 104 to save the pipeline in association with a unique uniform resource locator (URL) address. In some embodiments, the server 104 can also denormalize the pipeline such that updates to one or more aspects of the pipeline do not affect one or more other aspects that are unrelated to the updates.

In some embodiments, when a pipeline is saved, the server 104 can redirect the client device 102 to a different webpage (referred to as a “project view page”) to view the pipeline and/or one or more other pipelines permitted to be accessed by the server 104 with respect to the user. In this example, the server 104 can transmit data to the client device 102 to cause the client device 102 to display the project view page. While displayed, the user can provide input to the server 104 via the client device 102 to select a project to be edited, select a project to be deleted, and/or the like. When selecting to delete a given project, the server 104 can cause a confirmation message to be displayed via the project view page displayed on the client device 102. In some embodiments, the project view page can also be associated with an asset library. For example, the server 104 can maintain one or more listings of assets (e.g., datasets associated with context prompts accessible by the user, settings to be configured by the user, and/or the like). In some embodiments, the user can provide input to the server 104 via the client device 102 that causes the server 104 to display one or more windows to edit one or more hyperparameters associated with the pipeline. For example, the user can provide input to the server 104 to set one or more hyperparameters associated with the training of one or more machine learning models associated with a given pipeline and/or project template.

In some embodiments, the user can provide input to the server 104 via the client device 102 to cause the server 104 to export a pipeline. For example, the user can provide input to the server 104 via the client device 102 to cause the server to export the pipeline such that a different computing device (e.g., a different server) can receive data from one or more user devices 108, process the data in accordance with a pipeline and/or project template, and provide the output to the user device 108. In one illustrative example, the server 104 can export the pipeline by providing data associated with the pipeline to a client device 102 including a server that is managing access to a webpage. The server managing access to the webpage can then receive data via the webpage (e.g., via one or more fields of the webpage) representing a task prompt, process the data based at least in part on one or more components of the pipeline (e.g., a system prompt, context prompts, and/or the like) to generate an output, and provide data associated with the output via the webpage. In this way, the client device 102 can receive and configure a pipeline for use once exported by the server 104.

Referring now to FIG. 2A, FIG. 2A is an example user interface 200 in accordance with embodiments of the present disclosure. The user interface 200 can be the same as, or similar to, the first user interface discussed with respect to FIG. 1. In some embodiments, the user interface 200 can be displayed via a display device of one or more of client devices (e.g., one or more client devices that are the same as, or similar to, the client devices 102 of FIG. 1).

In some embodiments, the user interface 200 includes a first region 210, a second region 220, a third region 230, and a fourth region 240. In examples, the first region 210 can include one or more buttons or fields (or other graphical user interface elements) including a first field 210a, a first button 210b, a second button 210c, a third button 210d, and/or a fourth button 210e. The first field 210a can indicate a model from among a plurality of models that are implemented to receive and process data as described herein. The first button 210b can include a button that is selectable based at least in part on user input provided via a client device. The first button 210b can display a separate graphical user interface (e.g., a pop-up window) that enables the user to select (e.g., swap) the base model displayed in the first field 210a with a different model. In examples, input provided via the first button 210b can be independent of input provided at one or more other fields or buttons of the user interface 200. In some embodiments, the user interface 200 can include one or more default inputs (e.g., a default system prompt, a default base model, a default customization, a default seed, and/or the like).

In some embodiments, the second button 210c can cause the information provided as input via the one or more buttons and/or fields of the user interface 200 to be stored as a project template. For example, as a user configures one or more project templates to be implemented and/or published, a server (e.g., a server that is the same as, or similar to, the server 104 of FIG. 1) can receive input via the second button 210c that is configured to cause the server to save the information provided to the user interface 200 as a project template. The server can then store data associated with the project template in memory or in a database (e.g., a database that is the same as, or similar to, the database 106 of FIG. 1).

In some embodiments, the third button 210d can cause the user interface 200 to be reset. For example, in response to input from the client device indicating selection of the third button 210d, the one or more fields and/or buttons of the user interface 200 can be reset (e.g., set to default values). In some embodiments, the fourth button 210e can display a separate graphical user interface (e.g., a pop-up window) that enables the user to select one or more project templates. In examples, input provided via the fourth button 210e can cause the user interface 250 of FIG. 2D to be displayed via the client device. Once the user interface 250 is displayed, the user operating the client device can select one or more values of one or more fields based at least in part on predetermined values provided by users operating client devices, can publish a given project template for access by one or more other users (sometimes referred to as members) operating other client devices, and/or the like.

In some embodiments, the second region 220 can include an input field 220a, a first button 220b, and a second button 220c. The input field 220a can be configured to receive and display text provided as input by the user operating the client device. For example, the input field 220a can receive text representing a system prompt based at least in part on input provided by a user operating a client device, as described herein. The first button 220b can be selected based at least in part on input provided by the user operating the client device after inputting the system prompt in the input field 220a. Once the first button 220b is selected, the server can save the system prompt in association with a project template represented by the user interface 200. One or more users can later retrieve the system prompt by providing input selecting the second button 220c. For example, the one or more users operating client devices can later retrieve the system prompt by providing input selecting the second button 220c that causes the user interface 250 of FIG. 2D to be displayed via the client device. Once the user interface 250 is displayed, the user operating the client device can provide input indicating a selection of one or more system prompts from among a plurality of published system prompts or system prompts associated with the user.

In some embodiments, the third region 230 can include an input field 230a and buttons 230b-230h. The input field 230a can be configured to receive and display text provided as input by the user operating the client device. For example, the input field 230a can receive text representing one or more strings of text as described herein. The buttons 230b-230h can be selected based at least in part on input provided by the user operating the client device. For example, users can provide input to client devices that indicates selection of the buttons 230b-230h. The server can then receive data from the client devices indicating the corresponding selections.

In some embodiments, the user can provide input by selecting a first button 230b of the third region 230 that causes the server to select one or more models that are pretrained to respond to inputs (e.g., task prompts) from user devices (e.g., user devices that are the same as, or similar to, the user devices 108 of FIG. 1). When the first button 230b is selected, the user can then provide input via the second button 230c to cause user interface 250 of FIG. 2D to be displayed via the client device. Once the user interface 250 is displayed, the user operating the client device can select one or more pretrained models. It will be understood that, in examples, the use of a pretrained model can be locked (e.g., cannot be further customized with strings of text associated with in-context learning as described herein). In this way, the user can provide input selecting one or more models to receive input(s) as described herein.

In some embodiments, the user can provide input by selecting a third button 230d of the third region 230 that causes the server to include an in-context learning prompt or one or more example strings of text stored by the server 104 as an input to an LLM (referred to as in-context learning). Once the third button 230d is selected, the user can select a fourth button 230e to import one or more example strings of text associated with a dataset. In this example, the input via the fourth button 230e can cause the user interface 250 of FIG. 2D to be displayed via the client device. In examples, the user can provide input via the user interface 250 by selecting a dataset identifier matching the one or more example strings of text. The server can then import the one or more example strings of text into the input field 230a. In examples where the user is creating a new in-context learning prompt or updating the existing in-context learning prompt, the user can provide input representing pairs of strings of text (training pairs or input pairs) to a new training dataset or an existing training dataset. Additionally, or alternatively, the user can provide input updating one or more existing pairs of strings of text. In some embodiments, the user can provide input by selecting a fifth button 230f that specifies a number of training pairs. For example, the user can provide input as a number (e.g., as illustrated, “7”) which can cause the server to provide a corresponding number of fields in the input field 230a. The server can then retrieve a corresponding number of training pairs from a specified dataset and/or receive input at the corresponding fields of the input field 230a representing the training pairs. In an illustrative example, where a dataset includes 100 training pairs, and the number input via the fifth button indicates that only 7 training pairs should be retrieved for a given project template, the server can retrieve only 7 training pairs. In this illustrative example, the training pairs can be selected randomly by the server or based at least in part on input provided by the user operating the client device. As shown in FIG. 2B, a first input pair can include: “Tell a dad joke about a calendar.” “Joke: I'm afraid for the calendar. Its days are numbered,” and a second example for the given in-context learning prompt can include a second pair of strings: “Tell a dad joke about math.” “Joke: Dear math, grow up and solve your own problems.” The user can then provide input selecting a sixth button 230g to cause the server to save the training pairs in a new dataset or to update an existing dataset based at least in part on the inputs and/or updates to the training pairs.

In some embodiments, the user operating the client device can provide input by selecting a seventh button 230h of the third region 230 that causes the server to publish one or more project templates. For example, the user can provide input via the client device to cause the server to publish the one or more project templates displayed via the user interface 200. In this example, the user can provide input via the seventh button 230h which can cause the user interface 250 of FIG. 2D to be displayed via the client device. In examples, the user can provide input via the user interface 250 by selecting one or more other users and assign one or more permissions to the one or more other users.

In some embodiments, the user operating the client device can provide input by selecting an eighth button 230i of the third region 230. Selection of the eighth button 230i can cause the server to include a zero shot learning prompt or one or more example strings of text stored by the server 104 as an input to an LLM. For example, as shown in FIG. 2C, once the eighth button is selected the user operating the client device can provide input via the input field 230a including one or more strings representing instructions to be provided to the LLM. As an illustrative example, the input can include a string of text “Below you will be asked to tell various dad jokes. Fill in the requested joke after the prompt.” The server can prepend the string of text representing the instructions to be provided to the LLM to the task prompt when generating an input for the LLM. The server can then provide an input including the system prompt, the prepended string of text representing the instructions, and the task prompt to the LLM to cause the LLM to generate the outputs described herein.

In some embodiments, the fourth region 240 of the user interface can include an input field 240a, and buttons 240b-240e. The input field 240a can be configured to receive and display text provided as input by the user operating the client device and/or users operating user devices. For example, the input field 240a can receive text representing a task prompt as described herein. The buttons 240b-240e can be selected based at least in part on input provided by the user operating the client device. For example, users can provide input to client devices that indicates selection of the buttons 240b-240e. The server can then receive data from the client devices indicating the corresponding selections. In some embodiments, the fourth region 240 (or portions thereof) can be displayed in a separate graphical user interface (e.g., a pop-up window). For example, the server can cause a separate graphical user interface to be displayed via the corresponding client device based at least in part on input received by the client device selecting the button 240b or the button 240c that cause the server to provide data to a model as described herein.

In some embodiments, the user can provide input by selecting a first button 240b of the fourth region 240 that causes the server to provide data to a model. For example, the user can provide input by selecting the first button 240b after configuring a project template that causes the server to provide data to an LLM based at least in part on the configuration of the project template. In this example, the server can determine the system prompt, the task prompt, and/or one or more other inputs to the user interface 200 based at least in part on inputs provided by a user operating a client device as represented by the project template. In some embodiments, the server can update the input field 240a based at least in part on an output of a model. For example, the server can update the input field 240a to include one or more strings of text that are output by an LLM that received the data from the server. In some embodiments, the user can cause the server to provide updated data to the model by providing input via the fourth button 240d to indicate a seed and subsequently providing input selecting the third button 240c. In response to selection of the third button 240c, the server can provide the data to the LLM to cause the LLM to generate an output, the data provided to the LLM including a seed value corresponding to the seed input via the fourth button 240d. In some embodiments, the user can provide input by selecting a fourth button 240e to cause the server to generate the user interface 250 of FIG. 2D to be displayed via the client device.

Referring now to FIG. 2B, FIG. 2B is an example user interface 200′ in accordance with embodiments of the present disclosure. Components with the same, or similar, reference numerals as those identified in FIG. 2A may be the same as, or similar to, the components described with respect to FIG. 2A. In some embodiments, the user interface 200′ can be generated for display on a client device based at least in part on a user operating a client device providing input selecting button 230d. As illustrated, once the button 230d is selected, the input field 230a can be configured to receive and display text provided as input by the user operating the client device.

Referring now to FIG. 2C, FIG. 2C is an example user interface 200″ in accordance with embodiments of the present disclosure. Components with the same, or similar, reference numerals as those identified in FIG. 2A may be the same as, or similar to, the components described with respect to FIG. 2A. As illustrated in FIG. 2C, a user interface 200″ (which is the same as, or similar to, the user interface 200 of FIG. 2A) is illustrated after a user operating a client device provides input selecting button 230i. As illustrated, once the button 230i is selected, the input field 230a can be configured to receive and display a single string of text provided as input by the user operating the client device. In this example, the text can represent instructions that are provided (e.g., prepended) to the task prompt prior to the server providing data to an LLM to cause the LLM to generate an output as described herein.

Referring now to FIG. 2D, FIG. 2D is an example user interface 250 in accordance with embodiments of the present disclosure. The user interface 250 can be the same as, or similar to, one or more user interfaces discussed with respect to FIG. 1. In some embodiments, the user interface 250 can be displayed via a display device of one or more client devices (e.g., one or more client devices that are the same as, or similar to, the client devices 102 of FIG. 1). In some embodiments, the user interface 250 can be displayed via a display device of a client device (e.g., a client device that is the same as, or similar to, the client devices 102 of FIG. 1).

In some embodiments, the user interface 250 includes regions 252-262. In examples, a first region 252 can include an input field 252a. The input field 252a can display strings of text based at least in part on input provided by a user operating a client device. For example, when configuring a system prompt (e.g., a default system prompt that is common to all initial project templates), a user can provide input via a client device that represents a string of text. The client device can then display the string of text via the input field 252a. In examples, the user can provide input via the client device selecting a first button 252b of the first region 252 that causes the server to provide data to the client device to generate another user interface (e.g., a pop-up window, not explicitly illustrated). In other examples, the user can provide input via the client device selecting a second button 252c. In this example, selection of the second button 252c can enable the client device to receive input and edit the string(s) of text in the input field 252a.

In examples, a second region 254 can include a field 254a. The field 254a can display a listing of individual(s) operating other client devices that have access to a project template. In examples, the user operating the client device can provide input to remove one or more of the members. In other examples, the user operating the client device can provide input selecting a first button 254b. Selection of the first button 254b can cause the causes the server to provide data to the client device to generate another user interface (e.g., a pop-up window, not explicitly illustrated) listing one or more other users to receive access to the project template. In some examples, the user operating the client device can provide input selecting a second button 254c. Selection of the second button 254c can cause the server to provide data to the client device to generate another user interface (e.g., a pop-up window, not explicitly illustrated) listing one or more groups of users that, when selected, cause the server to provide such users with access to the project template.

In examples, a third region 256 can include a field 256a. The field 256a can display a listing of strings of text implemented by the project template. The strings of text can be associated with one or more in-context learning prompts or zero-shot learning prompts as described herein. In examples, the user operating the client device can provide input to remove one or more of the in-context learning prompts or zero-shot learning prompts. In other examples, the user operating the client device can provide input selecting a first button 256b. Selection of the first button 256b can cause the server to provide data to the client device to generate another user interface (e.g., a pop-up window, not explicitly illustrated) configured to receive one or more new in-context learning prompts or zero-shot learning prompts.

In examples, a fourth region 258 can include a field 258a. The field 258a can display a listing of datasets and/or dataset identifiers that are associated with a project template. In examples, the user operating the client device can provide input to remove one or more of the datasets associated with the field 258a. In other examples, the user operating the client device can provide input selecting a first button 258b. Selection of the first button 258b can cause the server to provide data to the client device to generate another user interface (e.g., a pop-up window, not explicitly illustrated) configured to receive one or more new datasets (e.g., identifiers corresponding to the one or more new datasets).

In examples, a fifth region 260 can include a field 260a. The field 260a can display a listing of endpoints (e.g., API endpoints) that have access to the project template. In some embodiments, the endpoints can provide access to the project template to one or more other client devices. In examples, the user operating the client device can provide input to remove one or more of the endpoints. In other examples, the user operating the client device can provide input selecting a first button 260b. Selection of the first button 260b can cause the server to provide data to the client device to generate another user interface (e.g., a pop-up window, not explicitly illustrated) configured to receive one or more new endpoints (e.g., identifiers corresponding to the one or more new endpoints).

In examples, a sixth region 262 can include a field 262a. The field 262a can display a listing of saved settings. In some embodiments, the user operating the client device can provide input to remove one or more of the saved settings. For example, the user can provide input selecting one or more of the saved settings that cause the server to remove one or more of the saved settings. In some embodiments, the settings can include one or more aspects of a given project template that are further modified by other users (e.g., users other than the current user configuring the project template).

Referring now to FIG. 2E, FIG. 2E is an example user interface 270 in accordance with embodiments of the present disclosure. The user interface 270 can be the same as, or similar to, one or more user interfaces discussed with respect to FIG. 1. In some embodiments, the user interface 270 can be displayed via a display device of one or more client devices (e.g., one or more client devices that are the same as, or similar to, the client devices 102 of FIG. 1). In some embodiments, the user interface 270 can be displayed via a display device of a client device (e.g., a client device that is the same as, or similar to, the client devices 102 of FIG. 1).

In some embodiments, the user interface 270 can include a field 270a that is configured to display a system prompt for a project template. The user interface 270 includes a first button 270b. In response to user input (via a client device) selecting the first button 270b, the server can save the system prompt displayed in the field 270a as a default system prompt for one or more project templates. The user interface 270 includes a second button 270c. In response to user input selecting the second button 270c, the server can save the system prompt in association with a project template (e.g., when a user initially generates and/or updates a system prompt). The user interface includes a third button 270d that corresponds to a scope. In response to user input selecting the third button 270d, a different graphical user interface (e.g., a pop-up window) can be displayed and the user can select a scope. In some embodiments, the scope can correspond to the user(s) that have access to the system prompt. In examples, the scope can be a single user (e.g., the user who generated the system prompt), one more other users, and/or an entire organization. In some embodiments, the user interface 270 can include a field 270e. The field 270e can be configured to receive user input. In response to a user providing input to name the system prompt (e.g., “Laughbot v2”) the server can associate the project template associated with the system prompt with the name. The user interface 270 can include a fourth button 270f. In response to user input selecting the fourth button, the server can generate and transmit data associated with a text file to the client device, the text file representing the project template.

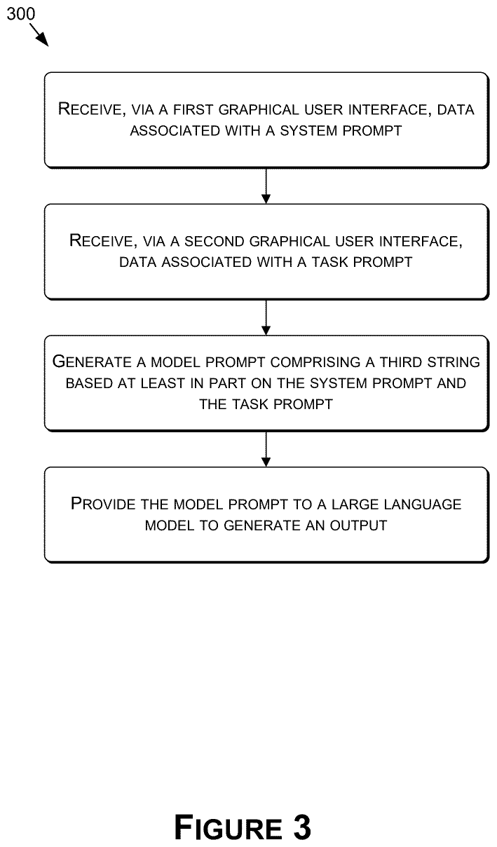

Now referring to FIG. 3, each block of method 300, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 300 is described, by way of example, with respect to the system of FIG. 1. However, this method may additionally or alternatively be executed by any one system, or any combination of systems, including, but not limited to, those described herein.

FIG. 3 is a flow diagram showing a method 300 for managing interactions with generative artificial intelligence models, in accordance with some embodiments of the present disclosure. The method 300, at block 302, includes receiving, via a first graphical user interface, data associated with a system prompt. For example, a server (e.g., a server that is the same as, or similar to, the server 104 of FIG. 1) can receive data associated with a system prompt based at least in part on user input provided via a client device (e.g., a client device that is the same as, or similar to, the client devices 102 of FIG. 1).

In some embodiments, the server can receive data associated with an indication of the LLM from among a plurality of LLMs. For example, the server can receive data associated with an indication of the LLM from among a plurality of LLMs, where each LLM of the plurality of LLMs are trained/updated based at least on different training dataset. In examples, the server can receive the data associated with an indication of the LLM from among a plurality of LLMs based at least in part on a user selecting the LLM via a graphical user interface.

In some embodiments, the server can receive data associated with a context prompt. For example, the server can receive data associated with a context prompt including one or more example strings of text. In examples, the data associated with the context prompt can specify a dataset identifier corresponding to a dataset. For example, the data associated with the context prompt can specify a dataset identifier corresponding to a dataset including one or more context prompts that are stored (e.g., by the server and/or accessible from a database that is the same as, or similar to, the database 106 of FIG. 1).

In some embodiments, the server can generate a project template. For example, the server can generate a project template based at least in part on the system prompt and/or one or more other inputs provided by a client device. In this example, the server can generate a project template and save the project template (e.g., in memory of the server or in a database) such that, when recalled, the values associated with the project template are prepopulated in a graphical user interface used to configure and/or update the project template.

The method 300, at block 304, includes receiving, via a second graphical user interface, data associated with a task prompt. For example, the server can receive the data associated with the task prompt based at least in part on user input provided via a client device or a user device (e.g., a user device that is the same as, or similar to, the user devices 108 of FIG. 1). In some embodiments, the data associated with the task prompt can include a string of text that is configured to cause an LLM to generate an output. In some embodiments, the server can receive the data associated with the task prompt based at least in part on an endpoint. For example, the server can receive the data associated with the task prompt based at least in part on an endpoint associated with a client device or a user device as described herein.

The method 300, at block 306, includes generating a model prompt comprising a third string based at least in part on the system prompt and the task prompt. For example, the server can generate the model prompt based at least in part on the server combining the system prompt (e.g., the string of text associated with the system prompt) with the task prompt (e.g., the string of text associated with the task prompt. In embodiments, the server can generate the model prompt based at least in part on the system prompt, a context prompt, and the task prompt. For example, the server can generate the model prompt based at least in part on the server combining the system prompt, the context prompt (e.g., the string of text associated with the context prompt representing an in-context prompt or a zero-shot context prompt), and the task prompt (e.g., the string of text associated with the task prompt. In examples, the server can determine the context prompt based at least in part on a dataset identifier and the server can generate the model prompt based at least in part on the strings of text associated with a dataset identified by the dataset identifier.

The method 300, at block 308, includes providing the model prompt to an LLM to generate an output. For example, the server can provide the model prompt to an LLM to cause the LLM to generate an output. In this example, the output can include an answer (represented as a string of text) that is determined based at least on a context associated with the third string of text. In some embodiments, the server can provide the model prompt to an LLM from among a plurality of LLMs specified by a user. For example, the server can provide the model prompt to an LLM from among a plurality of LLMs specified by a user when configuring a project template used by the LLM.

In some embodiments, the server can provide the model prompt and a seed to the LLM to cause the LLM to generate an output. For example, the server can receive data associated with a seed and the server can provide the model prompt and the seed to the model to cause the model to generate the output. In this example, the server can cause the model to introduce a degree of randomness to the output based at least in part on the seed. In some embodiments, the server can update the model prompt before providing the model prompt to the LLM such that the model prompt includes the seed.

### Example Computing Device

FIG. 4 is a block diagram of an example computing device(s) 400 suitable for use in implementing some embodiments of the present disclosure. Computing device 400 may include an interconnect system 402 that directly or indirectly couples the following devices: memory 404, one or more central processing units (CPUs) 406, one or more graphics processing units (GPUs) 408, a communication interface 410, input/output (I/O) ports 412, input/output components 414, a power supply 416, one or more presentation components 418 (e.g., display(s)), and one or more logic units 420. In at least one embodiment, the computing device(s) 400 may comprise one or more virtual machines (VMs), and/or any of the components thereof may comprise virtual components (e.g., virtual hardware components). For non-limiting examples, one or more of the GPUs 408 may comprise one or more vGPUs, one or more of the CPUs 406 may comprise one or more vCPUs, and/or one or more of the logic units 420 may comprise one or more virtual logic units. As such, a computing device(s) 400 may include discrete components (e.g., a full GPU dedicated to the computing device 400), virtual components (e.g., a portion of a GPU dedicated to the computing device 400), or a combination thereof.

In some embodiments, the computing device 400 of FIG. 4, or one or more components thereof, can be included in one or more of the devices of FIG. 1. Additionally, or alternatively, one or more of the devices involved in the generation or presentation of the graphical user interfaces described with respect to FIGS. 2A-2E. In some embodiments, one or more computing devices 400 can perform one or more of the operations described with respect to the method 300 of FIG. 3, either individually or in coordination with one or more other computing devices 400.

Although the various blocks of FIG. 4 are shown as connected via the interconnect system 402 with lines, this is not intended to be limiting and is for clarity only. For example, in some embodiments, a presentation component 418, such as a display device, may be considered an I/O component 414 (e.g., if the display is a touch screen). As another example, the CPUs 406 and/or GPUs 408 may include memory (e.g., the memory 404 may be representative of a storage device in addition to the memory of the GPUs 408, the CPUs 406, and/or other components). In other words, the computing device of FIG. 4 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 4.

The interconnect system 402 may represent one or more links or busses, such as an address bus, a data bus, a control bus, or a combination thereof. The interconnect system 402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 406 may be directly connected to the memory 404. Further, the CPU 406 may be directly connected to the GPU 408. Where there is direct, or point-to-point connection between components, the interconnect system 402 may include a PCIe link to carry out the connection. In these examples, a PCI bus need not be included in the computing device 400.

The memory 404 may include any of a variety of computer-readable media. The computer-readable media may be any available media that may be accessed by the computing device 400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 406 may be configured to execute at least some of the computer-readable instructions to control one or more components of the computing device 400 to perform one or more of the methods and/or processes described herein. The CPU(s) 406 may each include one or more cores (e.g., one, two, four, eight, twenty-eight, seventy-two, etc.) that are capable of handling a multitude of software threads simultaneously. The CPU(s) 406 may include any type of processor, and may include different types of processors depending on the type of computing device 400 implemented (e.g., processors with fewer cores for mobile devices and processors with more cores for servers). For example, depending on the type of computing device 400, the processor may be an Advanced RISC Machines (ARM) processor implemented using Reduced Instruction Set Computing (RISC) or an x86 processor implemented using Complex Instruction Set Computing (CISC). The computing device 400 may include one or more CPUs 406 in addition to one or more microprocessors or supplementary co-processors, such as math co-processors.

In addition to or alternatively from the CPU(s) 406, the GPU(s) 408 may be configured to execute at least some of the computer-readable instructions to control one or more components of the computing device 400 to perform one or more of the methods and/or processes described herein. One or more of the GPU(s) 408 may be an integrated GPU (e.g., with one or more of the CPU(s) 406 and/or one or more of the GPU(s) 408 may be a discrete GPU. In embodiments, one or more of the GPU(s) 408 may be a coprocessor of one or more of the CPU(s) 406. The GPU(s) 408 may be used by the computing device 400 to render graphics (e.g., 3D graphics) or perform general purpose computations. For example, the GPU(s) 408 may be used for General-Purpose computing on GPUs (GPGPU). The GPU(s) 408 may include hundreds or thousands of cores that are capable of handling hundreds or thousands of software threads simultaneously. The GPU(s) 408 may generate pixel data for output images in response to rendering commands (e.g., rendering commands from the CPU(s) 406 received via a host interface). The GPU(s) 408 may include graphics memory, such as display memory, for storing pixel data or any other suitable data, such as GPGPU data. The display memory may be included as part of the memory 404. The GPU(s) 408 may include two or more GPUs operating in parallel (e.g., via a link). The link may directly connect the GPUs (e.g., using NVLINK) or may connect the GPUs through a switch (e.g., using NVSwitch). When combined together, each GPU 408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 406 and/or the GPU(s) 408, the logic unit(s) 420 may be configured to execute at least some of the computer-readable instructions to control one or more components of the computing device 400 to perform one or more of the methods and/or processes described herein. In embodiments, the CPU(s) 406, the GPU(s) 408, and/or the logic unit(s) 420 may discretely or jointly perform any combination of the methods, processes and/or portions thereof. One or more of the logic units 420 may be part of and/or integrated in one or more of the CPU(s) 406 and/or the GPU(s) 408 and/or one or more of the logic units 420 may be discrete components or otherwise external to the CPU(s) 406 and/or the GPU(s) 408. In embodiments, one or more of the logic units 420 may be a coprocessor of one or more of the CPU(s) 406 and/or one or more of the GPU(s) 408.

Examples of the logic unit(s) 420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 410 may include one or more receivers, transmitters, and/or transceivers that enable the computing device 400 to communicate with other computing devices via an electronic communication network, included wired and/or wireless communications. The communication interface 410 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 420 and/or communication interface 410 may include one or more data processing units (DPUs) to transmit data received over a network and/or through interconnect system 402 directly to (e.g., a memory of) one or more GPU(s) 408.

The I/O ports 412 may enable the computing device 400 to be logically coupled to other devices including the I/O components 414, the presentation component(s) 418, and/or other components, some of which may be built in to (e.g., integrated in) the computing device 400. Illustrative I/O components 414 include a microphone, mouse, keyboard, joystick, game pad, game controller, satellite dish, scanner, printer, wireless device, etc. The I/O components 414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 400. The computing device 400 may be include depth cameras, such as stereoscopic camera systems, infrared camera systems, RGB camera systems, touchscreen technology, and combinations of these, for gesture detection and recognition. Additionally, the computing device 400 may include accelerometers or gyroscopes (e.g., as part of an inertia measurement unit (IMU)) that enable detection of motion. In some examples, the output of the accelerometers or gyroscopes may be used by the computing device 400 to render immersive augmented reality or virtual reality.

The power supply 416 may include a hard-wired power supply, a battery power supply, or a combination thereof. The power supply 416 may provide power to the computing device 400 to enable the components of the computing device 400 to operate.

The presentation component(s) 418 may include a display (e.g., a monitor, a touch screen, a television screen, a heads-up-display (HUD), other display types, or a combination thereof), speakers, and/or other presentation components. The presentation component(s) 418 may receive data from other components (e.g., the GPU(s) 408, the CPU(s) 406, DPUs, etc.), and output the data (e.g., as an image, video, sound, etc.).

### Example Data Center

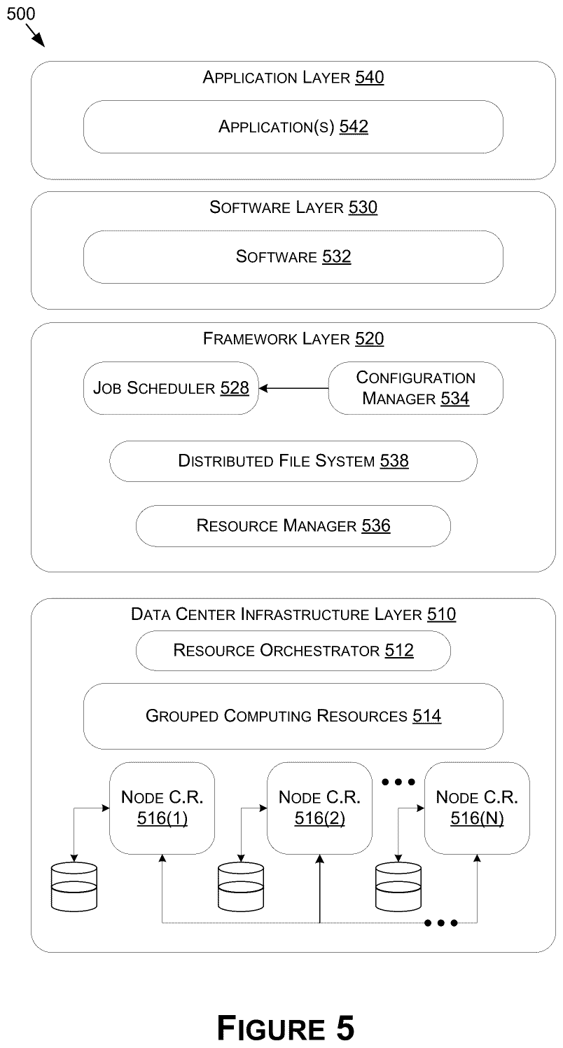

FIG. 5 illustrates an example data center 500 that may be used in at least one embodiments of the present disclosure. The data center 500 may include a data center infrastructure layer 510, a framework layer 520, a software layer 530, and/or an application layer 540.

As shown in FIG. 5, the data center infrastructure layer 510 may include a resource orchestrator 512, grouped computing resources 514, and node computing resources (“node C.R.s”) 516(1)-516(N), where “N” represents any whole, positive integer. In at least one embodiment, node C.R.s 516(1)-516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 516(1)-516 (N) may correspond to a server having one or more of the above-mentioned computing resources. In addition, in some embodiments, the node C.R.s 516(1)-5161(N) may include one or more virtual components, such as vGPUs, vCPUs, and/or the like, and/or one or more of the node C.R.s 516(1)-516(N) may correspond to a virtual machine (VM).

In some embodiments, the data center 500 of FIG. 5, or one or more components thereof, can be included in one or more of the devices of FIG. 1. Additionally, or alternatively, one or more of the devices involved in the generation or presentation of the graphical user interfaces described with respect to FIGS. 2A-2E. In some embodiments, the data center 500 can perform one or more of the operations described with respect to the method 300 of FIG. 3, either individually or in coordination with one or more other data centers 500.

In at least one embodiment, grouped computing resources 514 may include separate groupings of node C.R.s 516 housed within one or more racks (not shown), or many racks housed in data centers at various geographical locations (also not shown). Separate groupings of node C.R.s 516 within grouped computing resources 514 may include grouped compute, network, memory or storage resources that may be configured or allocated to support one or more workloads. In at least one embodiment, several node C.R.s 516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 512 may configure or otherwise control one or more node C.R.s 516(1)-516(N) and/or grouped computing resources 514. In at least one embodiment, resource orchestrator 512 may include a software design infrastructure (SDI) management entity for the data center 500. The resource orchestrator 512 may include hardware, software, or some combination thereof.

In at least one embodiment, as shown in FIG. 5, framework layer 520 may include a job scheduler 528, a configuration manager 534, a resource manager 536, and/or a distributed file system 538. The framework layer 520 may include a framework to support software 532 of software layer 530 and/or one or more application(s) 542 of application layer 540. The software 532 or application(s) 542 may respectively include web-based service software or applications, such as those provided by Amazon Web Services, Google Cloud and Microsoft Azure. The framework layer 520 may be, but is not limited to, a type of free and open-source software web application framework such as Apache Spark™ (hereinafter “Spark”) that may utilize distributed file system 538 for large-scale data processing (e.g., “big data”). In at least one embodiment, job scheduler 528 may include a Spark driver to facilitate scheduling of workloads supported by various layers of data center 500. The configuration manager 534 may be capable of configuring different layers such as software layer 530 and framework layer 520 including Spark and distributed file system 538 for supporting large-scale data processing. The resource manager 536 may be capable of managing clustered or grouped computing resources mapped to or allocated for support of distributed file system 538 and job scheduler 528. In at least one embodiment, clustered or grouped computing resources may include grouped computing resource 514 at data center infrastructure layer 510. The resource manager 536 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 538 of framework layer 520. One or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516 (N), grouped computing resources 514, and/or distributed file system 538 of framework layer 520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 534, resource manager 536, and resource orchestrator 512 may implement any number and type of self-modifying actions based on any amount and type of data acquired in any technically feasible fashion. Self-modifying actions may relieve a data center operator of data center 500 from making possibly bad configuration decisions and possibly avoiding underutilized and/or poor performing portions of a data center.

The data center 500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 500. In at least one embodiment, trained or deployed machine learning models corresponding to one or more neural networks may be used to infer or predict information using resources described above with respect to the data center 500 by using weight parameters calculated through one or more training techniques, such as but not limited to those described herein.

In at least one embodiment, the data center 500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 400 of FIG. 4—e.g., each device may include similar components, features, and/or functionality of the computing device(s) 400. In addition, where backend devices (e.g., servers, NAS, etc.) are implemented, the backend devices may be included as part of a data center 500, an example of which is described in more detail herein with respect to FIG. 5.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs) such as RESTful APIs). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 400 described herein with respect to FIG. 4. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
receive, using a first graphical user interface (GUI), data associated with a system prompt including at least a first string of text;
receive, using the first GUI or a second GUI, data associated with a task prompt including at least a second string of text configured to cause a large language model (LLM) to generate an output;
generate a model prompt comprising a third string of text based at least on the first string of text and the second string of text; and
provide the model prompt to the LLM to cause the LLM to generate the output, the output including an answer that is determined based at least on a context associated with the third string of text.

2. The one or more processors of claim 1, wherein the one or more circuits are to:
receive data associated with an indication of the LLM from among a plurality of LLMs, where individual LLMs of the plurality of LLMs are trained using at least partially different training datasets or training parameters; and
provide the model prompt to the LLM to cause the LLM to generate the output based at least on the indication of the LLM.

3. The one or more processors of claim 1, wherein the one or more circuits are to:
receive data associated with one or more example strings of text,
wherein the model prompt is further generated based at least on the one or more example strings of text.

4. The one or more processors of claim 1, wherein the one or more circuits are to:
receive data associated with a dataset identifier; and
receive a dataset based at least on the dataset identifier, the dataset including one or more example strings of text,
wherein the model prompt is further generated based at least on the dataset.

5. The one or more processors of claim 1, wherein the one or more circuits are to:
receive data associated with a seed, the seed including a random number,
wherein the model prompt is further generated based at least on the seed.

6. The one or more processors of claim 1, wherein the one or more circuits that receive the data associated with a task prompt are to:
receive the data associated with the task prompt from an endpoint, the endpoint associated with display of at least one of the first GUI or the second GUI.

7. The one or more processors of claim 1, wherein the one or more circuits are to:
receive the data associated with the system prompt from a first device of a plurality of devices;
generate data associated with a project template based at least on the system prompt, the data configured to prepopulate one or more fields of the first graphical user interface based at least on the system prompt; and
store the data associated with the project template in a database, the database accessible by a second device of the plurality of devices.

8. The one or more processors of claim 7, wherein the one or more circuits are to:
receive a request for the project template from the second device of the plurality of devices;
determine the data associated with the project template based at least on the request; and
provide the data associated with the project template to the second device.

9. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing large language models (LLMs);
a system implementing vision language models (VLMs);
a system for hosting one or more real-time streaming applications;
a system for performing light transport simulation;
a system for performing collaborative content creation for 3D assets; or
a system implemented at least partially using cloud computing resources.

10. A method, comprising:
receiving, based at least on one or more first user inputs, data associated with a system prompt that includes at least a first string of text;
receiving, based at least on one or more second user inputs, data associated with a task prompt that includes at least a second string of text configured to cause a large language model (LLM) to generate an output;
generating a model prompt including at least a third string of text based at least on the first string of text and the second string of text; and
providing the model prompt to the LLM to cause the LLM to generate the output, the output including an answer that is determined based at least on a context associated with the third string of text.

11. The method of claim 10, comprising:
receiving data associated with an indication of the LLM from among a plurality of LLMs, where individual LLMs of the plurality of LLMs are trained using at least one of different training datasets or different training parameters; and
providing the model prompt to the LLM to cause the LLM to generate the output based at least on the indication of the LLM.

12. The method of claim 10, comprising:
receiving data associated with one or more example strings of text; and
generating the model prompt comprising the third string of text based at least on the first string of text, the second string of text, and the one or more example strings of text.

13. The method of claim 10, comprising:
receiving data associated with a dataset identifier;
receiving the dataset based at least on the dataset identifier, the dataset comprising one or more examples strings of text; and
generating the model prompt comprising the third string of text based at least on the first string of text, the second string of text, and the one or more example strings of text.

14. The method of claim 10, comprising:
receiving data associated with a seed, the seed comprising a random number; and
generating the model prompt comprising the third string of text based at least on the first string of text, the second string of text, and the seed.

15. The method of claim 10, wherein receiving the data associated with a task prompt comprises:
receiving the data associated with the task prompt from an endpoint, the endpoint associated with display of a graphical user interface.

16. The method of claim 10, comprising:
receiving the data associated with the system prompt from a first device of a plurality of devices;
generating data associated with a project template based at least on the system prompt, to prepopulate one or more fields of the first graphical user interface based at least on the system prompt; and
storing the data associated with the project template in a database, the database accessible by a second device of the plurality of devices.

17. The method of claim 16, comprising:
receiving a request for the project template from the second device of the plurality of devices;
determining the data associated with the project template based at least on the request; and
providing the data associated with the project template to the second device.

18. The method of claim 10, wherein the method is implemented in at least one of:
a control system for an autonomous or semi-autonomous machine;
a perception system for the autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for presenting at least one of augmented reality content, virtual reality content, or mixed reality content;
a system for hosting one or more real-time streaming applications;
a system implemented using an edge device;
a system implemented using a robot;
a system for performing conversational AI operations;
a system that implements one or more large language models (LLMs);
a system for generating synthetic data;
a system incorporating one or more virtual machines (VMs);
a system implemented at least partially in a data center; or
a system implemented at least partially using cloud computing resources.

19. A system comprising:
one or more processors to:
cause execution of an application that communicates, using one or more application programming interfaces (APIs), with an endpoint, the endpoint implementing a large language model (LLM) selected from a set of LLMs with a selected set of parameters, the selected set of parameters including at least one of a knowledge base for performing retrieval augmented generation (RAG), one or more customizations to the LLM, one or more customizations to a prompt generator, or one or more application-specific guardrails for aligning the LLM to an application-specific domain.

20. The system of claim 19, wherein the endpoint is configured using one or more graphical user interfaces (GUIs) and based at least on one or more inputs to the GUI that indicate at least one of a selection of the LLM from the set of LLMs, a selection of the knowledge base, a selection of the one or more customizations to the LLM, a selection of the one or more customizations to the prompt generator, or an indication of the one or more application-specific guardrails.

21. The system of claim 19, wherein the endpoint is dynamically and automatically updated, without requiring an update to the application, to implement updated or modified versions at least one of the LLM, the knowledge base, the one or more customizations to the LLM, the one or more customizations to the prompt generator, or the one or more application-specific guardrails.
